(19) United States
(12) Patent Application Publication
(10) Pub. No.: US 2024/0402655 A1
(43) Pub. Date: Dec. 5, 2024

(54) APPARATUS AND METHOD FOR ASCERTAINING SAMPLING POINTS OF A SIGNAL PULSE

(71) Applicant: Forschungszentrum Jülich GmbH, Jülich (DE)

(72) Inventors: Christian Grewing, Jülich (DE); Lioubov Jokhovets, Düren (DE); Stefan van Waasen, Hückelhoven (DE)

(21) Appl. No.: 18/693,726

(22) PCT Filed: Aug. 15, 2022
(86) PCT No.: PCT/EP2022/072783

§ 371 Date: Mar. 20, 2024

(30) Foreign Application Priority Data
Oct. 1, 2021 (DE) 102021211092.4

(51) Int. Cl. G04F 10/10; G04F 10/00

(52) U.S. Cl. CPC G04F 10/105; G04F 10/005

(57) ABSTRACT

The present disclosure relates to a device for determining an arrival time of a signal pulse, comprising a comparison means configured such that it compares the time course of a signal pulse (V(t)) with two reference values (V1, V2) and triggers a time analysis means (TDC) of the device when the signal pulse (V(t)) reaches a reference value (V1, V2), wherein the time analysis means (TDC) is configured such that it determines the time between the first and the second triggering, and wherein the device is configured such that it determines an arrival time of the signal pulse by means of the determined time and by means of the reference values (V1,V2). The device can be used to determine an arrival time of a signal pulse in a technically simple manner. The present disclosure also relates to a method for determining an arrival time.

### CROSS REFERENCE TO RELATED APPLICATIONS

This application is a national stage entry under 35 USC § 371 of PCT International Application Number PCT/EP2022/072783, filed 15 Aug. 2022, and claims priority to German Publication No. 10 2021 211 092.4, filed 1 Oct. 2021, the entire disclosures of each of which is expressly incorporated by reference herein.

### FIELD OF THE DISCLOSURE

The present disclosure relates to a device and a method for determining an arrival time of a signal pulse. In particular, the present disclosure relates to signal pulses generated by elementary particles in a detector.

### SUMMARY

A signal pulse in the sense of the present disclosure may occur in physical experiments in which events are detected such as the entry of an elementary particle into a detector. When a particle enters a detector, an electrical pulse and thus a measured value is generated by the detector. Such an electrical pulse is a signal pulse in the sense of the present disclosure.

A time-dependent electrical signal may thus occur, comprising a plurality of signal pulses. The electrical signal may be digitized. The digitized electrical signal may then be processed by a signal processing unit.

During signal processing, it may be of interest to be able to accurately determine the arrival time of an event and thus the arrival time of the signal pulse. According to the teachings known from the publication WO 2020/109117 A1 this is done, among other things, by determining two sampling points on the rising edge of a digitized signal pulse.

The present disclosure is intended to make it possible to determine an arrival time of a signal pulse by simple technical means.

The task of the present disclosure may be solved by a device comprising the features of the first claim. A method comprises the features of the additional claim for solving the task.

The device and method of the present disclosure are explained in more detail below with reference to figures.

### BRIEF DESCRIPTION OF THE DRAWINGS

The figures show

FIG. 1: first exemplary embodiment of the present disclosure;

FIG. 2: a graph showing determination arrival time TA;

FIG. 3 second exemplary embodiment of the present disclosure.

### DETAILED DESCRIPTION

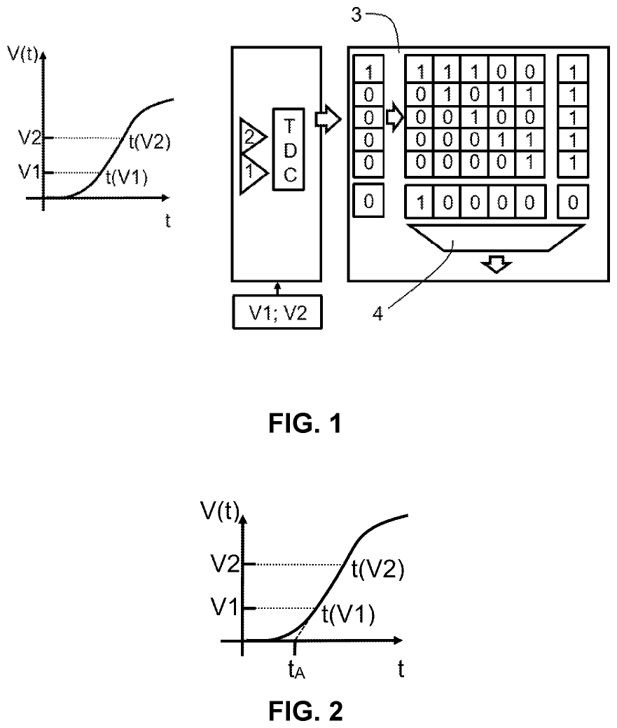

FIG. 1 shows two reference voltages V1 and V2, which are chosen to be in a middle range of a rising edge of a signal pulse. The signal pulse is a time-dependent electrical voltage V(t) which is pulse-shaped and which can be generated by a detector. In FIG. 1 the pulse-shaped rise V(t) of such a signal pulse is shown. A first comparator 1 compares the voltage V(t) with the reference voltage V1. A second comparator 1 compares the voltage V(t) with the reference voltage V2. When the voltage V(t) reaches the reference value V1, the comparator 1 triggers the TDC a first time. When the voltage V(t) reaches the reference value V2, comparator 2 triggers the TDC a second time. The TDC can measure in the nanosecond range and below. Thus, a time is determined that the signal pulse took to reach voltage V2 starting from voltage V1.

The TDC transfers the result to an electronic assembly that comprises an associative memory 3. This assembly first calculates the slope of the rising edge from the values obtained, and from this result the zero crossing TA (see FIG. 2). The result and thus the arrival time TA of the signal pulse can be output via an encoder 4.

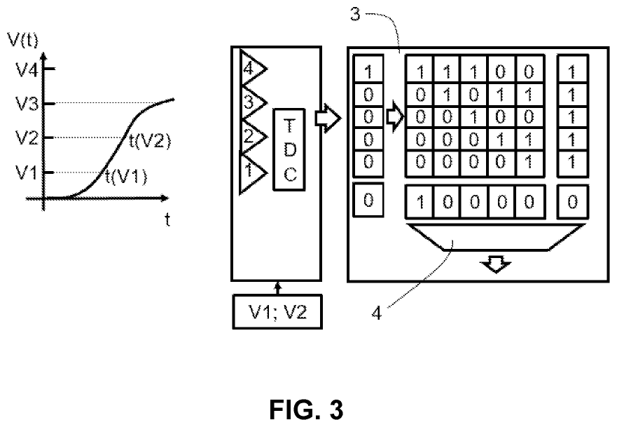

In the second exemplary embodiment of the disclosure shown in FIG. 3, there are four reference voltages V1, V2, V3 and V4 and four comparators 1, 2, 3, 4. Comparator 3 compares the reference voltage 3 with the voltage V(t) of the signal pulse. As soon as the value V3 is reached, the comparator triggers the TDC. The signal pulse shown in part in FIG. 3 does not reach the reference value V4. Therefore, the TDC is not triggered a fourth time by the comparator 4. From the information obtained in this way, improved conclusions can be drawn about the shape and course of the signal pulse. An arrival time can thus be determined in an improved manner. How the arrival time can then be determined can be found in the publication WO 2020/109117 A1.

The device comprises a comparison means, which compares the time course of a signal pulse with two reference values. If the signal pulse reaches the first reference value, a time analysis means is triggered. If the signal pulse reaches the second reference value, the time analysis means is triggered again. The time analysis means is configured such that it determines the time between the first and second triggering.

The first reference value is smaller than the second reference value. Thus, it can be determined whether a determined time relates to the rise of an edge of a signal pulse. By means of the reference values and the determined time, the arrival time of the signal pulse can then be determined.

In the detection of events that generate signal pulses in a detector, the typical amplitudes of signal pulses are known. Therefore, it is possible to select reference voltages such that they are reached by an edge of a signal pulse and, in particular, by a middle region of the edge of a signal pulse. If the reference points are suitably selected, the slope of the edge can be determined and from this a zero crossing can be determined. The zero crossing then reflects the time of arrival of the signal pulse.

The device may comprise a voltage source through which reference voltages can be provided. The device may comprise a regulating device by which a reference voltage can be adjusted. A reference voltage is then not fixedly predefined, but can be varied. However, an external voltage source can also be used for providing reference voltages.

In one embodiment, the comparison means is configured such that it compares the time course of a signal pulse with more than two reference values, such as with three or four reference values. If the signal pulse reaches the third reference value, the time analysis means is triggered. If the signal pulse reaches the optional fourth reference value, the time analysis means is triggered again. The same applies to further reference values. The time analysis means is configured such that it determines the time between the second and third triggering. If the time tracking is triggered a fourth time due to a fourth reference value, the time between the third and fourth triggering is determined, and so on.

The third reference value is greater than the second reference value. A fourth reference value is greater than a third reference value, etc.

The determination of a time that elapses for the signal pulse to reach the third reference voltage starting from the second reference voltage can be indirect or direct. For an indirect determination, for example, the time is determined that elapses for the signal pulse to reach the third reference voltage starting from the first reference voltage. The time required for the signal pulse to reach the second reference voltage from the first reference voltage can then be subtracted from this result. In this way, two different slopes of the rising edge of a signal pulse can be determined. The result can then be used in an improved manner to draw conclusions about the course of the rising edge of the signal pulse. If the course of the edge is known in an improved manner, the sought arrival time can be determined in an improved manner.

If a falling course of the pulse signal is determined, then this time can be discarded or used to determine the shape of the signal pulse.

By providing more than two reference values, it is in any case possible to determine a course of a rising edge that deviates from a straight course. A determined deviation from a straight course can be used to determine in an improved manner the arrival time of a signal pulse as known from the publication WO 2020/109117 A1. The provision of more than two reference values also minimizes the risk that signal pulses are not detected because reference values have been selected such that they do not lie on an edge of a signal pulse.

Thus, the shape of the rising edge of the signal pulse can be determined. The shape can be selected from a group comprising an at least substantially linear rise and a nonlinear rise without an inflection point. The group may also comprise a shape having a nonlinear rise with an inflection point. Based on a shape determined in this way, an arrival time can then also be determined particularly accurately as a function thereof.

In one embodiment of the present disclosure, the comparison means comprises at least one, preferably at least two comparators. Preferably, the comparison means comprises one comparator for each reference value.

A comparator is an electronic circuit that compares two voltages. A signal is available at the output of the comparator indicating which of the two input voltages is higher. The signal thus also indicates when both input voltages are equal. If the two input voltages are equal, the time analysis means is triggered. One input voltage at a comparator is then one of the reference voltages. The other input voltage that is present at the comparator is then the voltage that has been generated, for example, by a detector.

In one embodiment, the time analysis means comprises a time-to-digital converter (TDC). A time-to-digital converter is an electronic component that is able to measure short time intervals in the nanosecond range and convert them into a digital output. A time-to-digital converter can thus resolve very short times.

The time analysis means may comprise a frequency counter, if high time resolutions, as can be achieved with a time-to-digital converter, are not important.

Times between two trigger signals can be determined by a time-to-digital converter as well as by a frequency counter.

By means of the present disclosure, the arrival time of a signal pulse can be determined with simple technical means. In particular, the technical effort is significantly lower compared to the technical effort that must be expended in the teaching known from WO 2020/109117 A1.

The device and method of the present disclosure can also be used to determine other properties of a signal pulse. For example, the time at which the inflection point of a signal pulse occurred can be determined.

1. A device for determining an arrival time of a signal pulse, the device comprising a comparison means configured such that it compares the time course of a signal pulse (V(t)) with two reference values (V1, V2) and triggers a time analysis means (TDC) of the device when the signal pulse (V(t)) reaches a reference value (V1, V2), wherein the time analysis means (TDC) is configured such that it determines the time between the first and second triggering, and wherein the device is configured such that it determines an arrival time of the signal pulse by means of the determined time and by means of the reference values (V1, V2).

2. The device of claim 1, wherein the device comprises a voltage source by means of which the reference voltages (V1, V2) can be provided.

3. The device of claim 1, wherein the device is configured such that it compares the time course of a signal pulse (V(t)) with a third reference value (V3) and triggers a time analysis means (TDC) of the device when the signal pulse (V(t)) reaches the third reference value (V1, V2), wherein the time analysis means (TDC) is configured such that it determines the time between the second and third triggering, and wherein the device is configured such that it determines an arrival time (TA) of the signal pulse by means of the determined time and by means of the reference values (V1, V2, V3).

4. The device of claim 2, wherein the device is configured such that it compares the time course of a signal pulse (V(t)) with a third reference value (V3) and triggers a time analysis means (TDC) of the device when the signal pulse (V(t)) reaches the third reference value (V1, V2), wherein the time analysis means (TDC) is configured such that it determines the time between the second and third triggering, and wherein the device is configured such that it determines an arrival time (TA) of the signal pulse by means of the determined time and by means of the reference values (V1, V2, V3).

5. The device of claim 1, wherein the time analysis means comprises a time-to-digital converter (TDC) for a determination of the time between a first and a second triggering.

6. The device of claim 2, wherein the time analysis means comprises a time-to-digital converter (TDC) for a determination of the time between a first and a second triggering.

7. The device of claim 3, wherein the time analysis means comprises a time-to-digital converter (TDC) for a determination of the time between a first and a second triggering.

8. The device of claim 4, wherein the time analysis means comprises a time-to-digital converter (TDC) for a determination of the time between a first and a second triggering.

9. The device of claim 1, wherein the device comprises an electronic assembly (3, 4) for determining an arrival time (TA).

10. The device of claim 1, wherein the device comprises an electronic assembly (3, 4) for determining an arrival time (TA).

11. The device of claim 2, wherein the device comprises an electronic assembly (3, 4) for determining an arrival time (TA).

12. The device of claim 3, wherein the device comprises an electronic assembly (3, 4) for determining an arrival time (TA).

13. The device of claim 5, wherein the device comprises an electronic assembly (3, 4) for determining an arrival time (TA).

14. A method for determining an arrival time, the method comprising providing a device comprising:
a comparison means configured such that it compares the time course of a signal pulse (V(t)) with two reference values (V1, V2) and triggers a time analysis means (TDC) of the device when the signal pulse (V(t)) reaches a reference value (V1, V2), wherein the time analysis means (TDC) is configured such that it determines the time between the first and second triggering, and wherein the device is configured such that it determines an arrival time of the signal pulse by means of the determined time and by means of the reference values (V1, V2), and generating via the detector a pulse-shaped electrical signal (V(t)) and the time course of the signal pulse (V(t)) is compared with two reference values (V1, V2) and the time analysis means (TDC) of the device is triggered when the signal pulse (V(t)) reaches a reference value (V1, V2), wherein the time analysis means (TDC) determines the time between the first and the second triggering, and wherein an arrival time (TA) of the signal pulse is determined by means of the determined time and by means of the reference values (V1, V2).

15. The method of claim 14, wherein the detector is a detector for elementary particles.

16. The method of claim 14, wherein the device comprises a voltage source by means of which the reference voltages (V1, V2) can be provided.

17. The method of claim 14, wherein the device is configured such that it compares the time course of a signal pulse (V(t)) with a third reference value (V3) and triggers a time analysis means (TDC) of the device when the signal pulse (V(t)) reaches the third reference value (V1, V2), wherein the time analysis means (TDC) is configured such that it determines the time between the second and third triggering, and wherein the device is configured such that it determines an arrival time (TA) of the signal pulse by means of the determined time and by means of the reference values (V1, V2, V3).

18. The method of claim 16, wherein the device is configured such that it compares the time course of a signal pulse (V(t)) with a third reference value (V3) and triggers a time analysis means (TDC) of the device when the signal pulse (V(t)) reaches the third reference value (V1, V2), wherein the time analysis means (TDC) is configured such that it determines the time between the second and third triggering, and wherein the device is configured such that it determines an arrival time (TA) of the signal pulse by means of the determined time and by means of the reference values (V1, V2, V3).

19. The method of claim 14, wherein the time analysis means comprises a time-to-digital converter (TDC) for a determination of the time between a first and a second triggering.

20. The method of claim 14, wherein the device comprises an electronic assembly (3, 4) for determining an arrival time (TA).
